(19) United States
(12) Patent Application Publication
(10) Pub. No.: US 2013/0216087 A1
(43) Pub. Date: Aug. 22, 2013

(54) Earbud Positioning Device

(71) Applicant: Scott Lewis MacDonald, (US)

(72) Inventor: Scott Lewis MacDonald, (US)

(21) Appl. No.: 13/400,531

(22) Filed: Feb. 20, 2012

(51) Int. Cl. H04R 1/10

(52) U.S. Cl. 381/381

(57) ABSTRACT

An apparatus that securely positions a typical earbud-type earphone outside of the ear canal which allows users to concurrently listen to sounds from the speaker and sounds from the outside environment. It is comprised of an earhook that rests over and behind the user's ear with a fastener connected to one end to grip the stem of a conventional earbud. When the speaker is repositioned just outside of the ear canal, there is nothing physically blocking the entrance of the ear canal, thus allowing the user to hear what is going on around them. This provides a much safer manner in which a user can listen to their audio device. The apparatus is fully adjustable allowing the user to control the amount of outside noise that is heard along with the sounds from the earbud speaker by varying the proximity of the speaker to the ear canal.

### CROSS-REFERENCE TO RELATED APPLICATIONS

Not applicable.

### BACKGROUND

1. Field of Invention

This invention relates to earphone devices that reproduce sound from various types of audio equipment, specifically to the type of earphone that is designed to be inserted into the ear canal of the user, commonly referred to as an “earbud”.

2. Description of Prior Art

Over the last few decades, portable personal audio devices have become increasingly more popular. One of the most common types of earphones utilized these days is the “earbud” style earphone that is designed to be inserted into the ear canal of the user. It is a common sight to see people doing all types of activities with earbuds in their ears.

The main problem with current earbuds is the fact that they block some or all of the surrounding noise. This can be very dangerous if the user is engaging in any activities out in public where situational awareness is absolutely necessary. Bicycling, jogging, skating, and even walking are far more dangerous when the individual cannot hear what is going on around them. The dangers of blocking out surrounding outside noise if obvious to most people, yet many continue to do so at their own peril. The enjoyment of listening to one's own music is often chosen over one's own safety. According to The Los Angeles Times article published Jan. 16, 2012, a study found that accidents involving pedestrians wearing headphones have tripled in recent years. Of the 116 accidents studied between 2004 and 2011, 55% were pedestrians being hit by trains, and 70% of the accidents were fatal. Engaging in any activity in public or outdoors is more dangerous when the individual blocks out the outside (hereafter also referred to as ambient) noise. Being able to hear one's surroundings (footsteps, bicycles, vehicles, animals, etc.) should be of utmost importance.

There have been attempts to solve this problem while still allowing the individual to listen to their music. U.S. Patent Publication No. US 2002/0012441 by Matsunaga and Segawa discloses a body set type speaker unit comprising a mounting member and a directional speaker positioned at a predetermined distance away from a user's ear. However, the drawback to this design, as shown in Prior Art FIG. 3, is that it needs to securely suspend a speaker a set distance out in space away from the user's ear. In order for it to be secure, especially if the user is going to be engaged in any type of activity, the apparatus needs to be fairly bulky, uncomfortable to wear, and complex to manufacture.

Another attempt to allow users to concurrently hear their personal audio devices and also hear ambient noise is disclosed in U.S. Patent Publication No. US 2007/0258613 by Wright. Wright discloses a wearable apparatus that has speakers close to the ears positioned within a range of zero to eight inches from the auditory canal and may be surrounded by baffles that focus the sound toward the ear canal. Prior Art FIG. 4 shows a speaker that is hanging off of the top of the user's ear, without the user having the option to adjust, reposition, or re-align the speaker. The disadvantage of this design is lack of adjustability. Adjustability is important due to the fact that individual ear shapes vary greatly, as do activities and desired amount of allowable outside noise. This lack of adjustability prevents the user from obtaining a secure and comfortable fit, or a satisfying listening experience.

Another attempt to solve the same problems is disclosed in U.S. Patent Publication No. US 2008/0123890 by Peng. As shown in Prior Art FIG. 5, Peng's design utilizes a “Sound Transmission Tube” extending from the speaker toward the pinna of a user's ear without directing the sound toward the user's ear canal. The disadvantage of this design is that it relies on a more expensive technology as compared to the relatively simple earbud to accurately reproduce the desired sound and transmit it via the tube. Furthermore, it would be difficult to manufacture a unit that would be adjustable to fit a wide array of individual users.

Another attempt to solve this problem is U.S. Patent Publication No. US 2001/0050997 by Cho, which discloses a Holder-Ring for Earphone Plug, and is comprised of a flange with a plurality of small holes attached to the earbud. The holes are meant to allow outside sound to enter the ear canal along with the sounds from the users personal audio device. The disadvantage to this design is that even if the earbud flange allows sound to pass through, the earbud itself is still a physical encumbrance to the ear canal and therefore will affect the user's ability to accurately determine a sound's direction or origin.

Other designs have been proposed that involve re-designing the typical earbud itself to allow ambient noises to travel through the earbud along with the sound from the user's audio device—for example, U.S. Pat. Nos. 6,668,064 (2003) and 6,704,429 (2004) both to Lin. The disadvantages of this design is that even if the earbud allows sound to pass through, the earbud itself is still a physical encumbrance to the ear canal and therefore will affect the user's ability to accurately determine a sound's direction or origin. It also requires the user to purchase an entirely new earbud.

### SUMMARY

The main object of the earbud positioning device is to provide a secure, comfortable, lightweight, and inexpensive means to re-position a standard earbud type earphone. The earbud positioning device allows the user to adjust and control the amount of outside noise that can be heard concurrently with the audio signals of the user's personal audio device. It is an earhook type holder comprised of a curved body having a gripping aperture at one end that will securely hold the stem of an earbud, with the curved body fitting behind the user's ear.

### OBJECTS AND ADVANTAGES

Accordingly, several objects and advantages of this earbud positioning device are:
a. To provide an apparatus that positions a standard earbud in a manner that allows outside noises to be heard along with the user's personal audio device
b. To provide an apparatus that is much safer to use than the standard earbud by allowing outside noises to be heard, such as vehicles, bicycles, voices, footsteps, animals, horns, etc.
c. To provide an apparatus that comfortably places the earbud speaker just outside of the ear canal opening
d. To provide an apparatus that allows outside noises to enter the ear canal freely, so that the directional perception of the origin of the sounds is not inhibited
e. To provide an apparatus that securely holds the earbud in the optimal position even while the user engages in vigorous activities
f. To provide an apparatus that allows the user to adjust the placement of the earbud to control the desired amount of outside noise that is able to be heard
g. To provide an apparatus that helps to reduce damage to user's hearing by re-positioning the speaker outside of the ear canal
h. To provide an apparatus that is comfortable for the user to wear
i. To provide an apparatus that can be easily removed as to allow the earbud to be used in the traditional manner
j. To provide an apparatus that is lightweight
k. To provide an apparatus that is easy and inexpensive to manufacture

### DRAWING FIGURES

FIG. 1 is a side view of a typical human ear.

FIG. 2 shows Prior Art of the standard use and placement of an earbud in a typical ear.

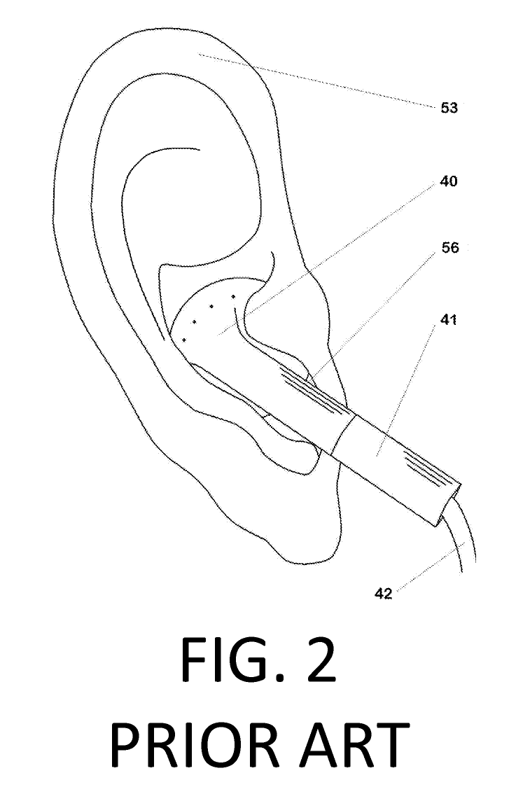

FIG. 3 shows Prior Art of U.S. Patent Publication No. US 2002/0012441 by Matsunaga and Segawa.

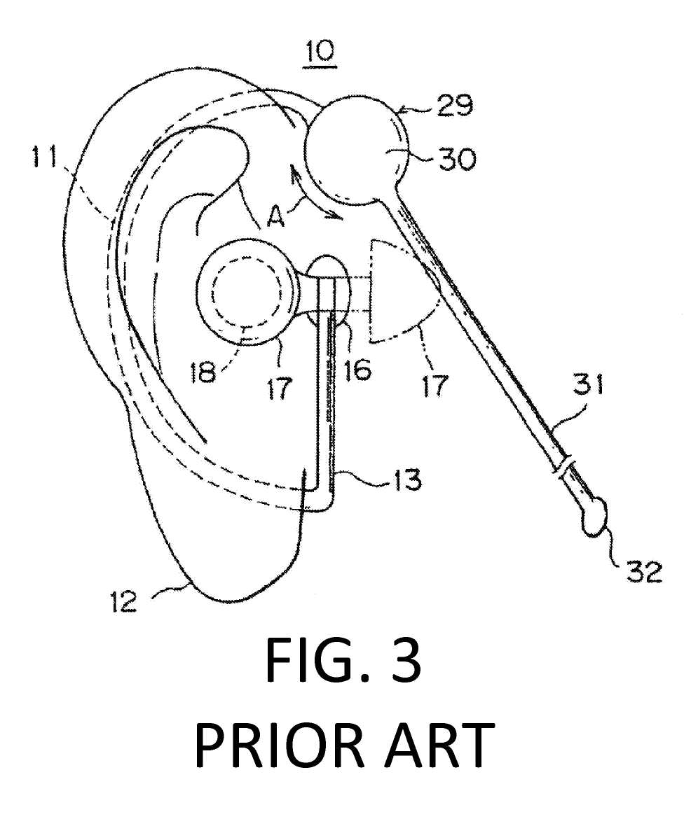

FIG. 4 shows Prior Art of U.S. Patent Publication No. US 2007/0258613 by Wright.

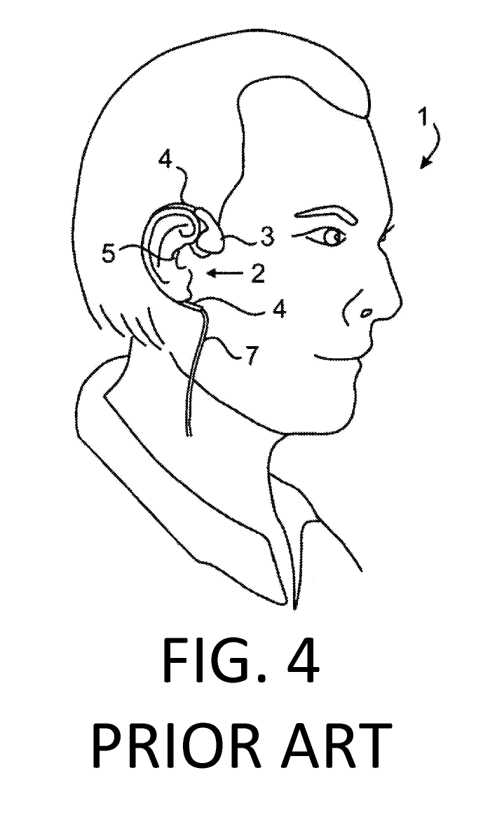

FIG. 5 shows Prior Art of U.S. Patent Publication No. US 2008/0123890 by Peng.

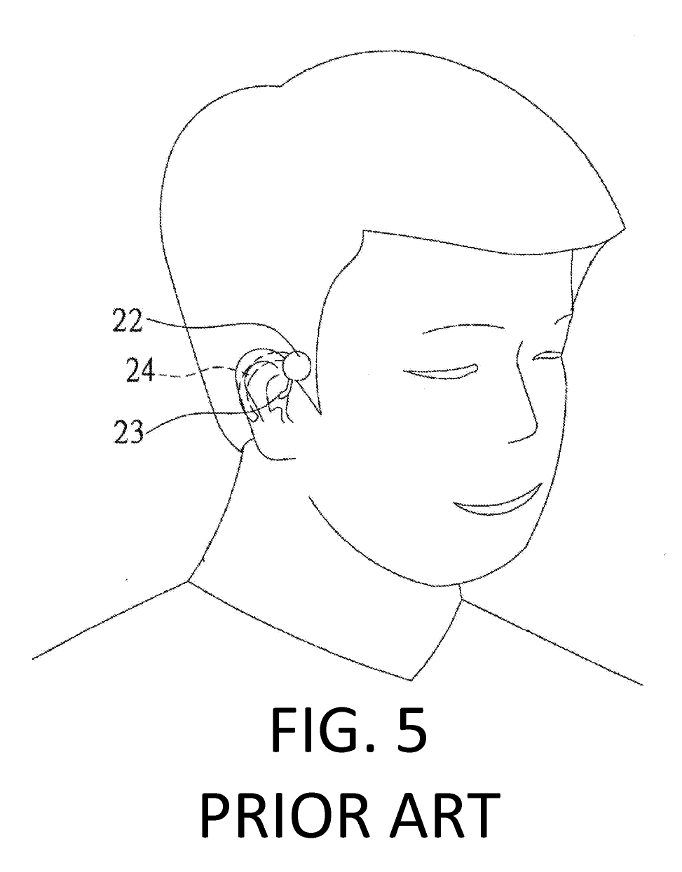

FIG. 6 is a perspective view of the earbud positioning device.

FIG. 7 is a side view of the earbud positioning device showing how it will attach to a typical earbud, which is shown as the dotted line portion.

FIG. 8 is a perspective view of the earbud positioning device with an earbud attached in the Intended manner.

FIG. 9 is a side view of the earbud positioning device worn on an ear in the intended manner.

### REFERENCE NUMERALS IN DRAWINGS

1-7 is from Prior Art of U.S. Patent Publication No. US 2007/0258613 by Wright:
1. Person wearing sound delivery apparatus
2. Sound Delivery Apparatus
3. Earbud
4. Arcuate Hanger
5. Ear Canal
7. Speaker Wire
   10-32 (excluding 22-24) is from Prior Art of U.S. Patent Publication No. US 2002/0012441 by Matsunaga and Segawa:

10. Ear-hanging type speakerphone unit
11. Ear hanging portion
12. Ear lobe
13. Speaker support
16. Universal Joint Portion
17. Directional speaker
18. External Auditory Miatus
29. Bone-conduction type speaker
30. Housing Portion
31. Plastically Deformable Tube
32. Microphone

22-24 is from Prior Art of U.S. Patent Publication No. US 2008/0123890 by Peng:
22. Sound Reproduction Device
23. Sound Transmission Tube
24. Alternative Support member

40. Earbud Speaker
41. Earbud Stem
42. Speaker Wire
43. Earbud Fastener
44. Earhook
45. Speaker Wire Fastener
50. Antihelix
51. Upper Concha
52. Lower Concha
53. Helix
54. Crus of Helix
55. Tragus
56. Ear Canal

### DETAILED DESCRIPTION OF EARBUD POSITIONING DEVICE

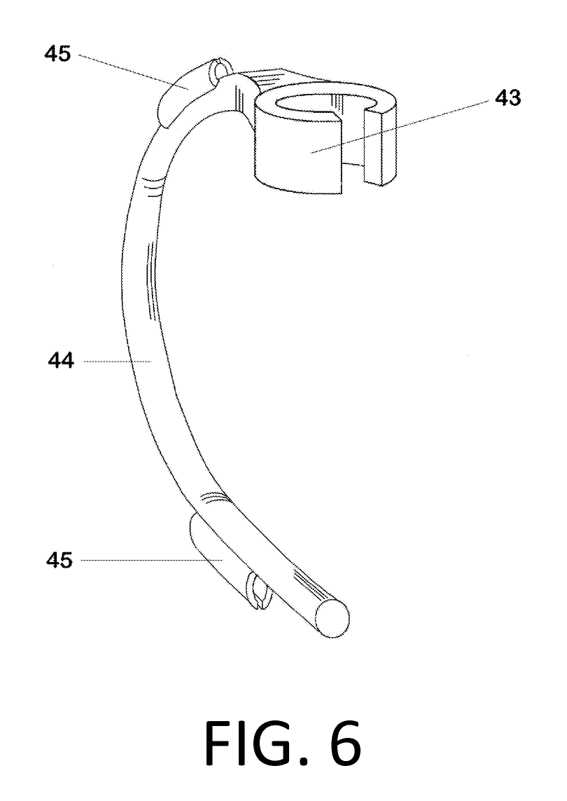

FIG. 6 shows a perspective view of a basic version of the earbud positioning device. It is comprised of a curve-shaped earhook 44 which has two speaker wire fasteners 45 attached to the outside edge of the curve. Attached to the top of earhook 44 is an earbud fastener 43.

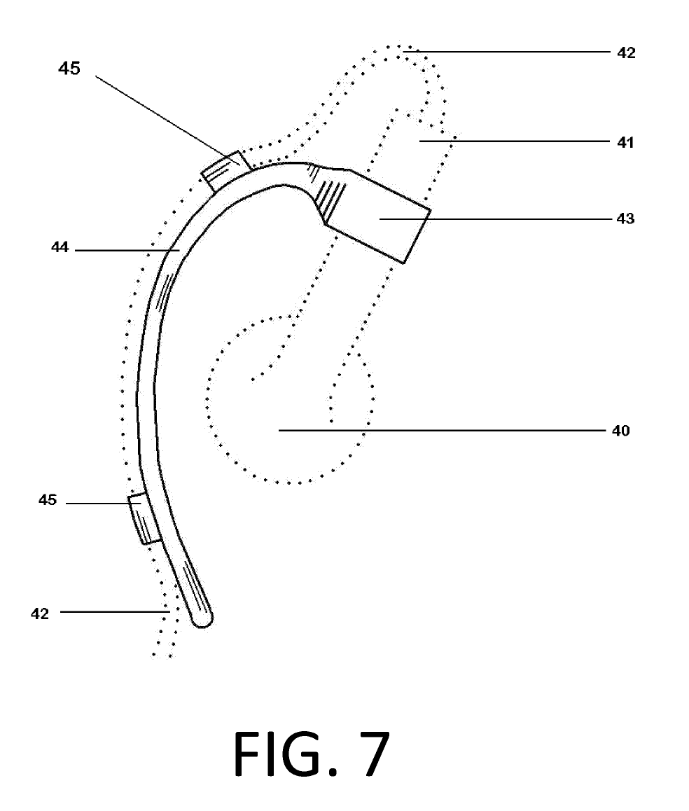

FIG. 7 shows a side view of the earbud positioning device and how it relates to an earbud that it is attached to, which is shown as the dotted line portion. Earbud fastener 43 secures the earbud in place by frictionally gripping or clamping onto earbud stem 41. This allows the user to adjust the position of earbud speaker 40 by sliding earbud stem 41 up or down or rotating it up to 360 degrees relative to earbud fastener 43. Earbud stem 41 extends upward in relation to the normal configuration of an upright ear. Speaker wire 42 extends out of earbud stem 41 and is attached to earhook 44 utilizing speaker wire fasteners 45. Speaker wire 42 follows the curvature of earhook 44 and will extend to the user's audio device from behind the ear.

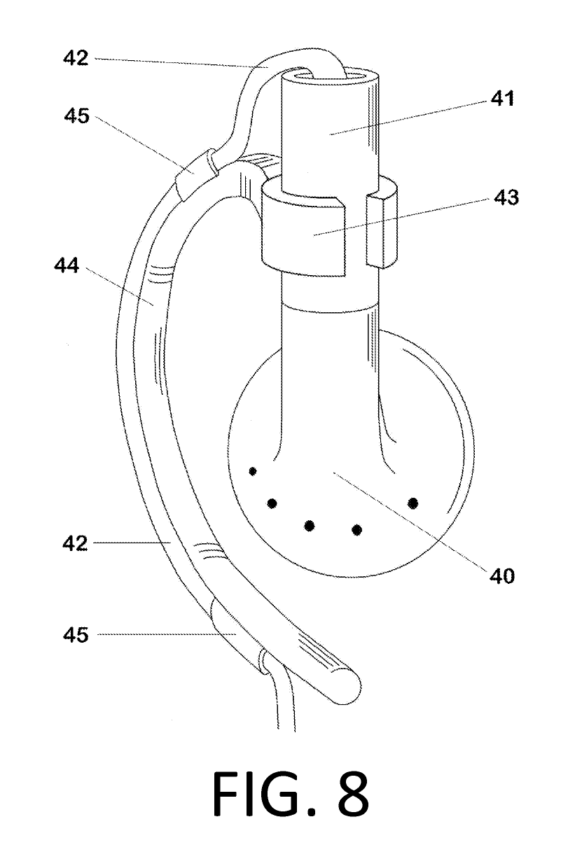

FIG. 8 shows a perspective view of the earbud positioning device and how it relates to an earbud that it is attached to. Earbud fastener 43 secures the earbud in place by frictionally gripping or clamping onto earbud stem 41. This allows the user to adjust the position of earbud speaker 40 by sliding earbud stem 41 up or down or rotating it up to 360 degrees relative to earbud fastener 43. Earbud stem 41 extends upward in relation to the normal configuration of an upright ear. Speaker wire 42 extends out of earbud stem 41 and is attached to earhook 44 utilizing speaker wire fasteners 45. Speaker wire 42 follows the curvature of earhook 44 and will extend to the user's audio device from behind the ear.

### Operation of Earbud Positioning Device

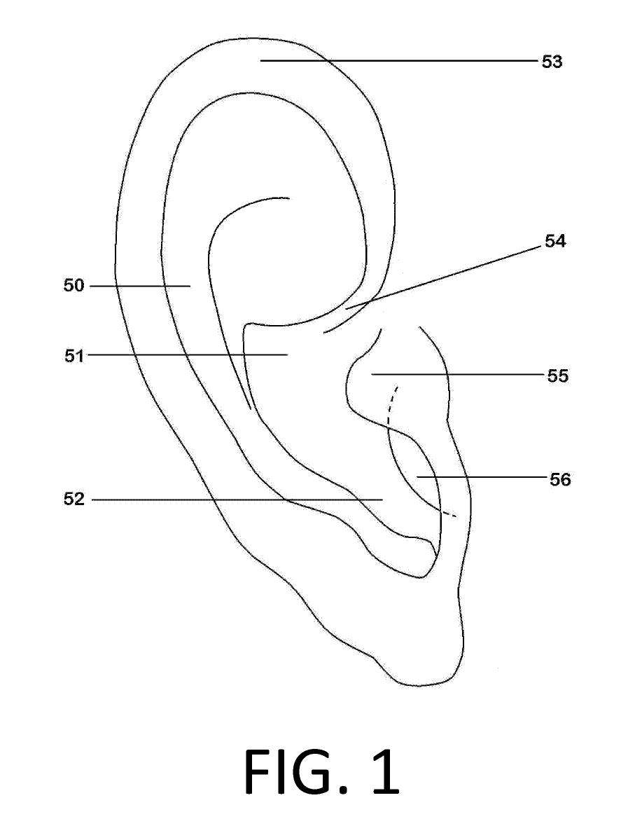

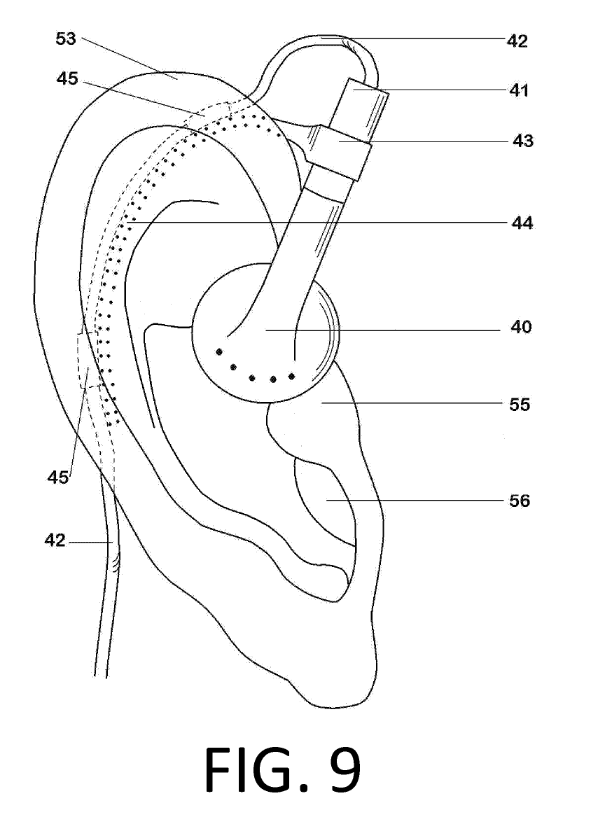

FIG. 9 shows a side view of the earbud positioning device and how it is intended to be worn on the user's ear. It is situated so that earbud speaker 40 is placed on the ear just above ear canal 56, and partially resting on or near Tragus 55, Crus of Helix 54 (FIG. 1), Antihelix 50 (FIG. 1), and upper Concha 51 (FIG. 1). This allows the sound from earbud speaker 40 to travel through the natural contours of Upper Concha 51 (FIG. 1) and Lower Concha 52 (FIG. 1) on its way to ear canal 56. In this manner, ambient noises are also allowed to enter ear canal 56 without being obstructed. Earbud speaker 40 is secured in the optimal position by earbud fastener 43 frictionally gripping earbud stem 41. Earbud fastener 43 is at the top end of earhook 44. Earhook 44 curves behind Helix 53 and stays in place by utilizing the properties of flexible tension. Earhook 44 is slightly stretched out when placed behind the user's ear, as the flexible nature of earhook 44 naturally exerts a small amount of force or tension as it tends to return to its original shape. This small amount of tension is enough to keep earhook 44 in position without exerting enough pressure on the user's ear to cause pinching or discomfort. Speaker wire 42 extends upwards from earbud stem 41 and is attached to earhook 44 utilizing speaker wire fasteners 45. Speaker wire 42 follows the curvature of earhook 44 and extends to the user's audio device from behind the ear.

FIG. 9 illustrates the “optimal position” of earbud speaker 40 as one example of how a user may prefer to position it. The design allows for individuals with varying ear shapes and varying needs as far as how much ambient noise is desired, to adjust the location of earbud speaker 40 in relation to the other parts of the ear, such as ear canal 56. Earbud stem 41 is removeably attached to earbud fastener 43.

In other embodiments, there may be one speaker wire fastener 45 along the outside edge of earhook 44.

In other embodiments, there may be a plurality of speaker wire fasteners 45 along the outside edge of earhook 44.

In other embodiments, speaker wire fasteners 45 may be replaced altogether by constructing earhook 44 with such a diameter that a groove could be incorporated into the outside edge of earhook 44 where speaker wire 42 could be inserted, and frictionally held in place.

In other embodiments, there may be alternate options of attaching earhook 44 to earbud stem 41. Instead of a clip style attachment, earbud fastener 43, which frictionally secures earbud stem 41, could be a spring loaded clamp, or a strap type fastener.

In other embodiments, there may be alternate options of securely attaching earhook 44 to earbud stem 41. A plastic or metal tube can be used to reinforce the rubber part of earbud stem 41 by being inserted inside the rubber housing and around speaker wire 42. This would give earbud fastener 43 a more rigid structure to attach to, thus providing the entire unit with more rigidity.

In other embodiments, there may be alternate options of securely attaching earhook 44 to earbud stem 41. A plastic or metal tube can be used to reinforce the rubber part of earbud stem 41 by forming a type of sleeve or cover and being positioned over and around earbud stem 41, giving earbud fastener 43 a more rigid structure to attach to, thus providing the entire unit with more rigidity.

In other embodiments, the area where earhook 44 meets earbud fastener 43 can also contain one or more apparatuses for further adjustability, including but not limited to: a swivel mechanism, hinge type mechanism, or ball and socket type mechanism.

In other embodiments, earhook 44 could be covered in a softer material such as a rubber compound for increased comfort.

In other embodiments, the earbud positioning device could be wireless altogether, eliminating the need for speaker wire 42 and speaker wire fastener 45. Earhook 44, earbud stem 41, and earbud speaker 40 could all be integrated as to include and house the components necessary for operating wirelessly (battery, radio receiver, etc.).

### Conclusion, Ramifications, and Scope

Accordingly, the reader will see that the adjustable earphone positioning device of this invention allows the user to utilize their current earbud type earphones by providing an apparatus that holds the earbud in a new manner that allows outside noises and sounds from their personal audio device to concurrently enter the ear canal unimpeded. The main advantage of the use of this invention is a much safer environment for the user regardless of the location or activity being performed.

The user will be able to determine what the optimum position is, based on the activities that are being performed while listening to their device. The adjustability of the earbud positioning device allows the user to determine the most comfortable position, as well as the amount of the outside noise they wish to hear. The earbud can be adjusted all the way up or down by sliding it through the clip, and rotated 360 degrees, therefore varying the proximity to the ear canal.

The second major problem with current earbuds is the fact that they can cause or at least contribute to hearing damage and hearing loss. There have been many studies that have proven this to be the case. The earbud positioning device removes the earbud from the ear canal, making it less likely to cause hearing damage as opposed to the traditional use of the earbud.

Furthermore, the earbud positioning device has the additional advantages in that
It makes use of and fits the most abundant types of earbud on the market today;
It allows the placement of the earbud to be more secure than the traditional use, solving the longstanding problem of earbuds falling out during even the most leisurely activities;
It is a very simple solution to longstanding problems that are widely known and accepted;
the earbud can be easily removed from the invention if the user wishes to utilize the earbud in the traditional manner and insert it in the ear canal;
It is a very lightweight design making its use comfortable to the user;
It permits a “one-piece” construction, helping to keep manufacturing costs low;
The adjustability of the invention allows the left and right side units to be identical, helping to keep manufacturing costs low by requiring only one mold to be made;
It permits the production in a variety of colors;

Although the description above contains many specificities, these should not be construed as limiting the scope of the earbud positioning device but as merely providing illustrations of some of the presently preferred embodiments of this invention. For example, it could be made in any range of colors or sizes in an attempt to make it fit as many people as possible. The earbud fastener can be made to accommodate different diameters of earbud stems, either larger or smaller, or even made as a clamp or strap or some other type of affixture in an attempt to fit a greater range of different sized earbud stems. The earbud itself could be specially designed to work with the earbud positioning device and integrated as one unit or sold as a set. The type of material that it is constructed of can also be varied. A wide variety of plastics or metals could be used with varying degrees of flexibility.

Thus the scope of the invention should be determined by the appended claims and their legal equivalents, rather than by the examples given.

I claim:

1. An apparatus for securely positioning an earbud-type earphone speaker worn by a person or user, comprising:
(a) a curved earhook section of somewhat flexible material of sufficient size to rest behind the ear of said user and
(b) a mounting member that is attached to one end of said earhook and
(c) a means of attaching to and securing said speaker to said mounting member in a position such that said speaker is of sufficient proximity to said user's ear canal for sounds emitted from said speaker to be heard concurrently with the ambient sounds of the surrounding environment
(d) whereby creating a safe listening environment for said user by positioning said speaker outside of said ear canal allowing said user to hear the ambient sounds while also listening to sounds emitted from said speaker.

2. The apparatus of claim 1, wherein there are two separate complete units, one for said user's right ear and one for said user's left ear, used separately or at the same time.

3. The apparatus of claim 2, wherein said speaker is detachably mountable to said mounting member.

4. The apparatus of claim 3, wherein said mounting member adjustably secures said speaker in position.

5. The apparatus of claim 4, whereby the possibility of said user experiencing hearing loss is reduced from the removal of said speaker from said ear canal.

6. The apparatus of claim 5, wherein said speaker is wireless, having a battery and a radio receiver built into said earhook section.

7. The apparatus of claim 5, wherein said speaker is wireless, having said battery and said radio receiver built into said speaker.
